(19) United States
(12) Patent Application Publication
(10) Pub. No.: US 2008/0096560 A1
(43) Pub. Date: Apr. 24, 2008

(54) System and method for ensuring handoffs across heterogeneous networks

(75) Inventors: Kent Felske, Kanata (CA); Abel Dasylva, Kanata (CA); Delfin Montuno, Kanata (CA); Guyves Achtari, Ottawa (CA); Eric Bernier, Ottawa (CA)

Correspondence Address: CHRISTOPHER & WEISBERG, P.A., 200 EAST LAS OLAS BOULEVARD, SUITE 2040, FORT LAUDERDALE, FL, 33301, US

(73) Assignee: Nortel Networks Limited

(21) Appl. No.: 11/585,476

(22) Filed: Oct. 24, 2006

(51) Int. Cl. H04Q 7/20

(52) U.S. Cl. 455/436

(57) ABSTRACT

This invention provides a system, method and apparatus for facilitating handoffs from a first communication network to a second communication network, the first communication network and second communication network being heterogeneous with respect to each other. The system, method and apparatus may further include a contextual information server, which stores contextual elements corresponding to a user device and the operating environment of the user device, and a handoff decision function module that evaluates at least one of the contextual elements to determine whether to handoff user device communications from the first communication network to the second communication network. The method and apparatus may further include obtaining at least one contextual element corresponding to a user device and the operating environment of the user device, evaluating the at least one contextual element with a handoff decision function module to establish a handoff decision, establishing a handoff decision, and notifying the user device of the handoff decision. The method for facilitating handoffs from a first communication network to a second communication network may further include receiving a received signal strength indication, receiving a link quality determination, receiving a characteristic of the user device, and determining the location of the user device.

### CROSS-REFERENCE TO RELATED APPLICATION

n/a

### STATEMENT REGARDING FEDERALLY SPONSORED RESEARCH OR DEVELOPMENT

n/a

### FIELD OF THE INVENTION

The present invention relates to communication networks, and more particularly to a method, system and apparatus that provides for control of call session handoffs across heterogeneous communication networks.

### BACKGROUND OF THE INVENTION

Wireless technologies are evolving toward broadband information access across multiple networking platforms as part of the demand for continuous availability of multimedia applications. Recent trends indicate that wide-area cellular networks based on second, third and fourth generation (“2G”, “3G” and “4G”) standards and wireless local area networks (“WLANs”) will co-exist to offer multimedia services to end users. A converged system can provide both universal coverage and broadband access by the strategic combination of these technologies. Therefore, the integration of heterogeneous networks is expected to become a main focus in the development toward the next generation wireless networks.

Mobility management is a main challenge in the converged network. Both intra-technology handoff and inter-technology handoff take place. Intra-technology handoff is the traditional horizontal handoff (“HHO”) process in which the mobile terminal (“MT”) hands-off between two access points (“AP”) or base stations (“BS”) using the same access technology. In contrast, inter-technology handoff, commonly referred to as vertical handoff (“VHO”) occurs when the MT roams between different access technologies. HHO is a symmetric process, while VHO is an asymmetric process in which the MT moves between two different networks with different characteristics. This introduces the concept of a preferred network, which is usually the WLAN that provides better throughput performance at lower cost, even if both networks are available and in good condition for the user.

There are two main scenarios in VHO: moving out of the preferred network (“MOUT”) and moving into the preferred network (“MIN”). For example, the current handoff function control is processed by the MT based on local measurement of signal strengths from the primary (e.g., wireless fidelity (“WiFi”)) and secondary (e.g., cellular) networks. In this scenario, the secondary (e.g., cellular) to primary (e.g., WiFi) handoff occurs when a new WiFi access point (“AP”) is detected and the AP signal strength is greater than a pre-selected high threshold parameter. On the other hand, a primary (e.g., WiFi) to a secondary (e.g., cellular) handoff occurs when the WiFi signal strength becomes less than a pre-selected low threshold parameter. These two handoffs rely on the received signal strength (“RSS”) as an indicator for service availability from a certain point of attachment, as well as for comparison between the current point of attachment and the candidate points of attachment. Presently, the use of poorly configured hysteresis thresholds by the mobile station or MT will typically result in poor handoff timing such as early handoff or late handoff.

On the one hand, late handoff decisions by the MT result in loss of basic connectivity, referred to as a “black hole” problem, when there is insufficient time for the completion of handoff operations, e.g., dynamic host configuration protocol (“DHCP”), mobile IP (“MIP”) signaling and other control signaling. On the other hand, early handoff decisions may produce a “ping pong” effect, which is where the MT is unnecessarily switching between WLAN and cellular networks and is characterized by excessive rates of handoffs, poor quality of service (“QoS”) for real-time flows, and excessive signaling load on network servers. The “ping pong” effect is rather pronounced in the urban environment where municipalities, enterprise and residential customers have massively deployed WLANs or wireless mesh networks and intend to use them as low-cost alternative to cellular systems, even for delay-sensitive traffic including voice.

For instance, in a building, a WLAN is operating and produces a radiated field at access point 1. As a result of an unshielded window, a portion of access point 1's radiated field leaks into the street located in front of the window. As a first user with a first handset walks by the unshielded window, the signal strength of the WLAN exceeds the high threshold value of the first handset, which causes the first handset to handoff to the WLAN at access point 1. A few feet later, the first user has exceeded the “leak” coverage area and now the signal strength of the WLAN is below a low threshold value of the first handset, which causes the first handset to handoff back to the cellular network. Thus the first user has experienced two consecutive and unnecessary handoffs that may have resulted in the temporary or permanent loss of the initiated call session.

This “ping pong” scenario further worsens where the there are multiple windows or where a window may have nonuniform shielding such as where the window has a metallic grid pattern that causes the single radiated field leak to be partitioned into four radiated field leaks. As a second user with a second handset walks by the unshielded window, the signal strength of the WLAN exceeds the high threshold value of the second handset, which causes the second handset to handoff to the WLAN at access point 1. A few feet later, the second user has exceeded the first external lobe of the “leak” coverage area and now the signal strength of the WLAN is below a low threshold value of the second handset, which causes the second handset to handoff back to the cellular network. This multiple handoff situation repeats itself for each of the four external lobes of the “leak” resulting in eight consecutive and unnecessary handoffs that may have resulted in the temporary or permanent loss of the initiated call session.

What is desired is an arrangement under which vertical handoff from one communications network to another communication network is controlled to provide maximum performance and optimal usage of communication network resources.

### SUMMARY OF THE INVENTION

It is to be understood that both the following summary and the detailed description are exemplary and explanatory and are intended to provide further explanation of the invention as claimed. Neither the summary nor the description that follows is intended to define or limit the scope of the invention to the particular features mentioned in the summary or in the description.

This invention provides a system, method and apparatus for facilitating handoffs from a first communication network to a second communication network, the first communication network and second communication network being heterogeneous with respect to each other. The system, method and apparatus may include a contextual information server, which stores contextual elements corresponding to a user device and the operating environment of the user device, and a handoff decision function module that evaluates the contextual elements to determine whether to handoff user device communications from the first communication network to the second communication network.

In accordance with one aspect, the present invention provides a system for facilitating handoffs between heterogeneous communication networks for a user device. The system for facilitating handoffs between heterogeneous communication networks including a first network having a first domain technology, a second network having a second domain technology different from the first domain technology, a contextual information server, which stores contextual elements corresponding to a user device and the operating environment of the user device, and a handoff decision function module that evaluates the contextual elements to determine whether to handoff user device communications from the first communication network to the second communication network. The handoff decision function module may further include a statistical and self-learning module, the statistical and self-learning module applying measured handover rates to target handover rates to dynamically adjust handover decision parameters.

In accordance with another aspect, the present invention provides a method for facilitating handoffs from a first communication network to a second communication network, the first communication network and second communication network being heterogeneous with respect to each other, by obtaining at least one contextual element corresponding to a user device and the operating environment of the user device, evaluating the at least one contextual element with a handoff decision function module to establish a handoff decision, establishing a handoff decision, and notifying the user device of the handoff decision. The method for facilitating handoffs from a first communication network to a second communication network may further include receiving a received signal strength indication, receiving a link quality determination, receiving a characteristic of the user device, and determining the location of the user device.

In accordance with another aspect, the present invention provides a method for facilitating handoffs from a first communication network to a second communication network, the first communication network and second communication network being heterogeneous with respect to each other, by retrieving user call service network preferences, the user call service network preferences establishing handoff parameters for evaluating a call session quality of service for a user device, determining the location of the user device within the first and second communication networks, and monitoring a signal strength received from the second network and evaluating the call session quality of service for the user device and applying the user device call service network preferences to the call session to determine whether to handoff user device communications from the first communication network to the second communication network. The method may further include comparing the signal strength received from the second network to a high threshold value, the high threshold value acting as a set point for call session handoff.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is a block diagram of the network architecture of an interworking heterogeneous wireless access network in accordance with the principles of the present invention;

FIG. 2 is a block diagram of a handoff decision function (“HDF”) within the network architecture of an interworking heterogeneous wireless access network in accordance with an embodiment of the present invention;

FIG. 3 is a detailed flowchart of an embodiment of the handoff decision function for facilitating handoffs in accordance with the principles of the present invention:

FIG. 4 is a detailed flowchart of another embodiment of the handoff decision function for facilitating handoffs in accordance with the principles of the present invention; and

FIG. 5 is a detailed flowchart of yet another embodiment of the handoff decision function for facilitating handoffs in accordance with the principles of the present invention.

### DETAILED DESCRIPTION OF THE INVENTION

This invention provides a method, system and apparatus for facilitating and ensuring handoffs across heterogeneous networks.

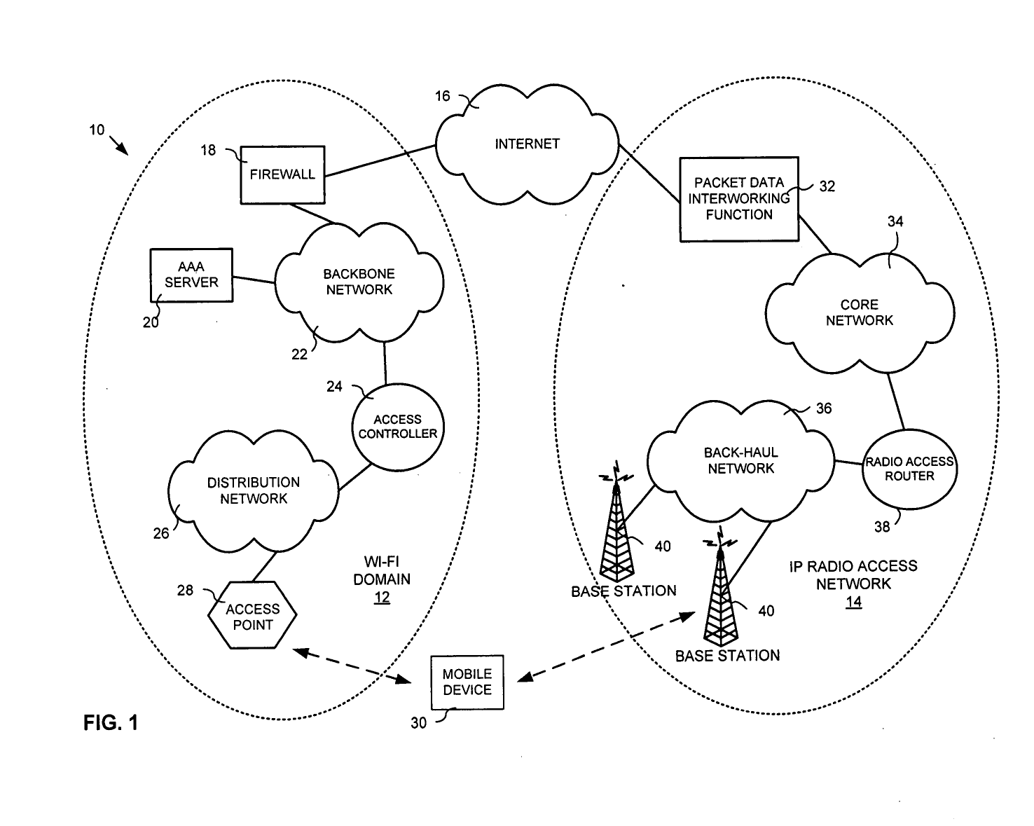

Referring now to the drawing figures in which like reference designators refer to like elements, there is shown in FIG. 1, a block diagram of the network architecture of an interworking heterogeneous wireless access network in accordance with the principles of the present invention and designated generally as “10”. The network 10 comprises a WLAN network 12 and an IP radio access network (“RAN”) 14. The WLAN network 12 includes access point (“AP”) nodes 28 which are two-way transceivers that broadcast data into the surrounding environment and typically act as mediators between wired and wireless networks. The AP nodes 28 typically operate in the unlicensed Institute of Electrical and Electronics Engineers (“IEEE”) standard 802.11 spectrum bands of 2.4 GHz and 5 GHz.

The WLAN network 12 includes a distribution network 26 (nonsecure) for connecting the AP nodes 28 to an access controller (“AC”) 24. The AC 24 functions to provide secure access to the backbone network 22 from the WLAN medium (e.g., distribution network 26 and AP nodes 28), mobility management, and configuration management of the AP nodes 28. The backbone network 22 is a secure network and provides connectivity between the interfacing networks, such as the Internet 16, and the distribution network 26. The authentication, authorization and accounting (“AAA”) server 20 provides the authentication, authorization and accounting in the WLAN Wi-Fi domain.

In general, authentication refers to the confirmation that a user who is requesting services is a valid user of the network services requested. Authentication is accomplished via the presentation of an identity and credentials. Examples of types of credentials include one-time tokens, passwords, digital certificates and telephone numbers (calling/called). Authorization typically refers to the granting of specific types of service (including “no service”) to a user, based on their authentication, what services they are requesting, and the current system state. Authorization may be based on restrictions, for example time-of-day restrictions, or physical location restrictions, or restrictions against multiple logins by the same user, and it determines the nature of the service to be granted to a user. Examples of types of service include, but are not limited to: IP address filtering, address assignment, route assignment, QoS services, bandwidth control, traffic management, encryption (decryption) and tunneling to a specific endpoint.

In general, accounting refers to the tracking of the consumption of network resources by users. This information may be used for management, planning, billing, or other purposes. Typical information that is gathered in accounting is the identity of the user, the nature of the service delivered, when the service began, and when it ended.

The WLAN network 12 further includes a firewall 18 which is generally defined as a piece of hardware and/or software that functions in a networked environment to prevent some communications forbidden by a security policy. A firewall may sometimes be referred to as a border protection device (“BPD”) or packet filter and it has the basic task of controlling traffic between different zones of trust. These typical zones of trust include the Internet (which is a zone with no trust) and an internal network (which is a zone with high trust). The ultimate goal is to provide controlled connectivity between zones of differing trust levels through the enforcement of a security policy and connectivity model based on the least privilege principle.

Continuing to refer to FIG. 1, the IP radio access network (“RAN”) 14 includes at least one base transceiver station (“BTS”) 40 which contains equipment for the transmission and reception of radio signals (i.e., transceivers), antennae, and equipment for encrypting and decrypting communications with a base station controller such as radio access router (“RAR”) 38. A BTS 40 provides communications with the mobile user device 30 (e.g., a dual mode handset telephone) over the radio interface. A back-haul network 36 provides transportation of traffic between the BTS 40 and the RAR 38. The RAR 38 controls the BTS 40 and performs various control functions such as load control, admission control, packet scheduling, handover control, macrodiversity combining, security functions, mobility management, and the like.

The IP RAN network 14 further includes a packet data interworking function (“PDIF”) 32 which acts as the gateway into the core network 34 and the packet data services domain of the back-haul network 36, e.g., where the network is a code division multiple access (“CDMA”) or cdma2000 technology. The PDIF 32 may include mobile Internet protocol (“MIP”) foreign agent (“FA”) functionality for MIP version 4 (“MIPv4”) and MIP version 6 (“MIPv6”) access. MIP is an Internet Engineering Task Force (“IETF”) standard communications protocol that is designed to allow mobile user device 30 to move from one network to another while maintaining its permanent IP address. The PDIF 32 may implement end-to-end secure tunnel management procedures between itself and the mobile user device 30, including establishment and release of a tunnel (via a tunneling protocol such as IP security (“IPSec”)).

The PDIF 32 may also provide allocation of an IP address to the mobile user device 30 from the operator's network, e.g., the cdma2000 network, and provide for the encapsulation and de-capsulation of traffic to and from the mobile user device 30, as well as enforcing the operator's policies such as packet filtering and routing. For example, the operator's policies may provide for different restrictions on network access based on certain times or days, or on whether the employee is a member of management. In addition, the PDIF 32 may also support user (e.g., mobile user device 30) authentication and transfer of authorization policy though the interface to the home AAA (“H-AAA”).

The mobile user device 30 may include a wide range of portable electronic devices, including but not limited to mobile phones, personal data assistants (“PDA”) and similar devices, which use the various communication technologies such as advanced mobile phone system (“AMPS”), time division multiple access (“TDMA”), code division multiple access (“CDMA”), global system for mobile communications (“GSM”), general packet radio service (“GPRS”), 1× evolution-data optimized (abbreviated as “EV-DO” or “1×EV-DO”) and universal mobile telecommunications system (“UMTS”).

A typical cellular to WLAN, e.g., Wi-Fi, vertical handoff is now discussed with reference to FIG. 1. First, the mobile user device 30, e.g., a dual-mode handset, associates with the WLAN. On its cellular interface (e.g., BTS 40), the handset 30 obtains the address of the target PDIF 32 from the RAR 38 and requests the creation of an IPSec tunnel. The RAR 38 requests the creation of an IPSec tunnel from the PDIF 32, which transmits a response. The RAR 38 informs the handset 30 of the creation of the tunnel by the PDIF 32. The PDIF 32 and the handset 30 exchange keys using, for example, the Internet key exchange (“IKE”) protocol and confirm the creation of the tunnel and exchange mobile IP anchor update.

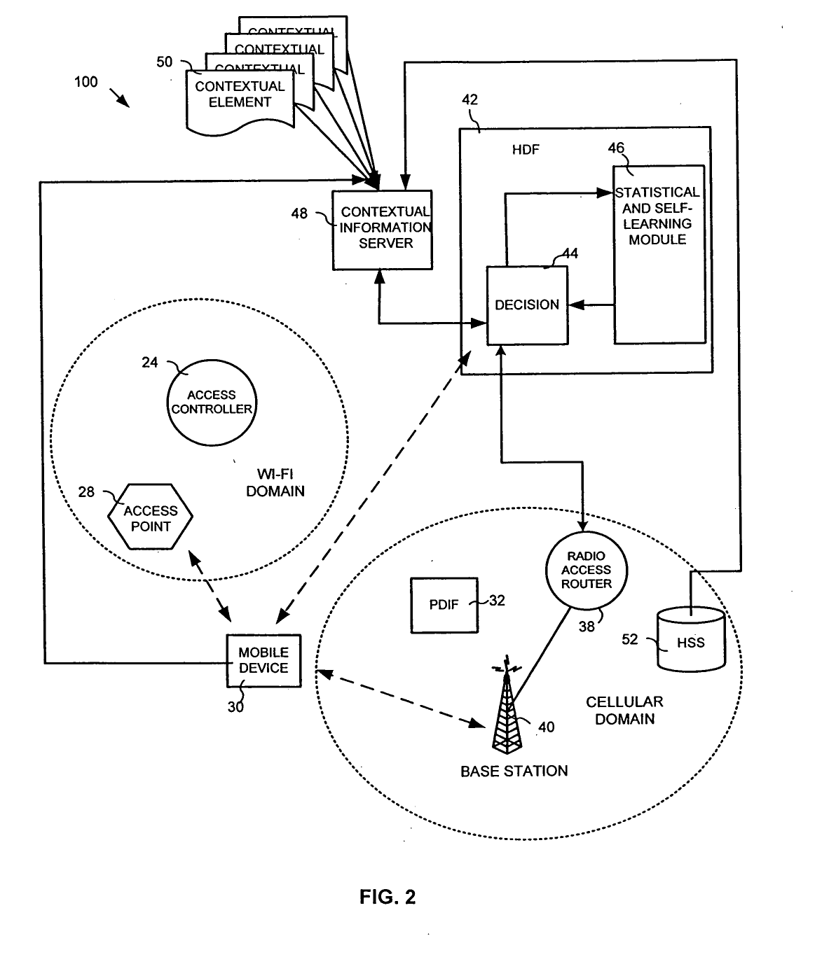

FIG. 2 illustrates a block diagram of a handoff decision function (“HDF”) 42 within the network architecture of an interworking heterogeneous wireless access network 100 in accordance with an embodiment of the present invention. In this embodiment, the HDF 42 is coupled to a RAR 38, the mobile device 30 and a contextual information server 48, which is coupled to contextual element(s) 50 and a home subscriber server (“HSS”) 52. The AC 24, AP nodes 28, the PDIF 32, the RAR 38 and the BTS 40 each function as discussed above with respect to FIG. 1.

The contextual information server 48 of network 100 provides contextual elements 50, to the HDF 42 for processing and analysis to determine when a handoff should occur from one communication domain to another communication domain. The contextual elements 50 are contextual information relating to the mobile device and its operating environment; which are gathered from a variety of sources as described below. The contextual elements 50 include but are not limited to: received signal strength indication (“RSSI”), mobile device location, communication link quality, AP load, user mobile device preference, mobile device characteristics, application type, mobile device velocity, mobile device direction, and AP/cell site ID.

The contextual element of RSSI may be provided by, but is not limited to, the mobile device 30 or the radio access router 38. The contextual element of mobile device location may be provided via, but is not limited to, a global positioning satellite (“GPS”), a cellular assisted GPS, a WiFi-based location system, a proximity sensor, AP association, a cell site association, e.g., home location register (“HLR”) or HSS 52, and an ultra-wideband location system. The communication link quality and/or QoS may be provided by, but is not limited to, an AP reporting traffic load, an AP reporting packet error rate, network monitoring of packet loss, a router reporting packet loss or queue fill rate, and a signal-to-noise ratio (“SNR”) on an air interface.

The user mobile device preference may be provided by, but is not limited to, input via a system interface, input via the user mobile device, and via a user profile in the HSS 52. The user mobile device characteristics, e.g., support of 802.11e QoS mechanisms, support of 802.1×authentication (security feature), and support of power-save protocol (such as legacy mode or WiFi multimedia power-save) may be provided by, but are not limited to, the user mobile device 30 and the HSS 52.

The application type, e.g., video, voice or data, may be provided by, but is not limited to, an application client and application servers. Information about the type of applications used by the user mobile device 30 can be used in a VHO decision by adjusting other HO parameters according to whether the user is running real-time applications, e.g., voice, video, or not. For example, when the decision to make a VHO to the WLAN results from the comparison of the WLAN RSSI with thresholds, the user may select different pre-configured thresholds depending on whether he is having a real-time conversation (voice/video) or not, at the time the decision has to be made. A higher threshold may be selected if the user mobile device is having a real-time conversation as opposed to when user mobile device is only sending and receiving best-effort and background traffic.

The velocity of the user mobile device 30 may be derived from the location of the user mobile device 30 when there are at least two readings of location information obtained at different instants in time. The direction of the user mobile device 30 may be derived from the location, when there are at least two readings of location information obtained at different instants in time.

The AP/cell site ID may be provided by but is not limited to, the AP, the cell site and the mobile device 30. Information about the ID of a cell site or WLAN AP may be used in a VHO decision, for example when the ID is a clear indication of the administrative domains of the candidate networks (cellular and WLAN), and the user is restricted to roaming networks either being in the same administrative domain or having a roaming agreement with its administrative domain. For example, a user may wish to make VHOs to secure WLANs within its enterprise network, but not to other WLANs in the same enterprise, which do not offer the same level of security. A second category of WLANs may be provided for visitors on the campus. The two categories of WLANs may be part of two different administrative domains and identified by different ranges of basic service set identifiers (“BSSID”) and service set identifiers (“SSID”).

Any of the above contextual elements 50 may be described as the handoff decision parameters that are available to the HDF module 42 for evaluation. Accordingly, any one or more of the handoff decision parameters, i.e., modified or unmodified contextual elements 50 are evaluated by the HDF module 42 to make a handoff determination that is communicated to the user mobile device 30. All the modified or unmodified contextual elements 50 correspond to the user mobile device 30 and/or the various networks or subnetworks that serve as the operating environment for the user mobile device 30.

The HDF 42 includes a decision block 44 and a statistical and self-learning module 46, which can include storage for storing handoff (“HO”) statistics obtained from the network 100 and mobile device 30. The HO statistics may include information regarding the actual handoffs that occur on the interworking heterogeneous wireless access network 100 and may be stored in tables or registers within the statistical and self-learning module 46. For example, the HO statistics may be obtained from a set of counters that measure the handoffs that occur on the network 100. The HDF 42 may utilize any of the contextual elements 50 to make handoff decisions and notify a user mobile device 30 when to execute a handoff.

The statistical and self-learning process module 46 may also include self learning processes, which are executed in the network-based HDF decision block 44, to obtain handoff statistics from the network 100 and mobile device 30. Control targets or handoff parameters may be set administratively by the network operator, e.g., the carrier or the enterprise. For example, the handoff control parameters may vary depending on which part of the network the user 30 is located based on the number of access points or base transceiver terminals; or based on the traffic load. In one embodiment, the target handoff rates associated with different classes of customers are obtained. The actual handoff rates over different regions of the network are measured and the handoff decision parameters are dynamically adjusted to best match the target handoff rates over the entire network. If the handoff rates are too great, then an increase in the difference between a high threshold (“HI TRSH”) value and a low threshold (“LO TRSH”) value using a hysteresis-like handoff decision function will decrease or slow down the actual handoff rate.

The decision block 44 may include a dwell timer (not shown) that provides a latency factor or delay for use by the HDF 42 in its handoff decision-making process. The dwell timer may provide a typical latency factor in the range of 10 msec to 100 msec, but the range may be on the order of seconds in certain circumstances. The dwell timer is an example of a handoff decision parameter.

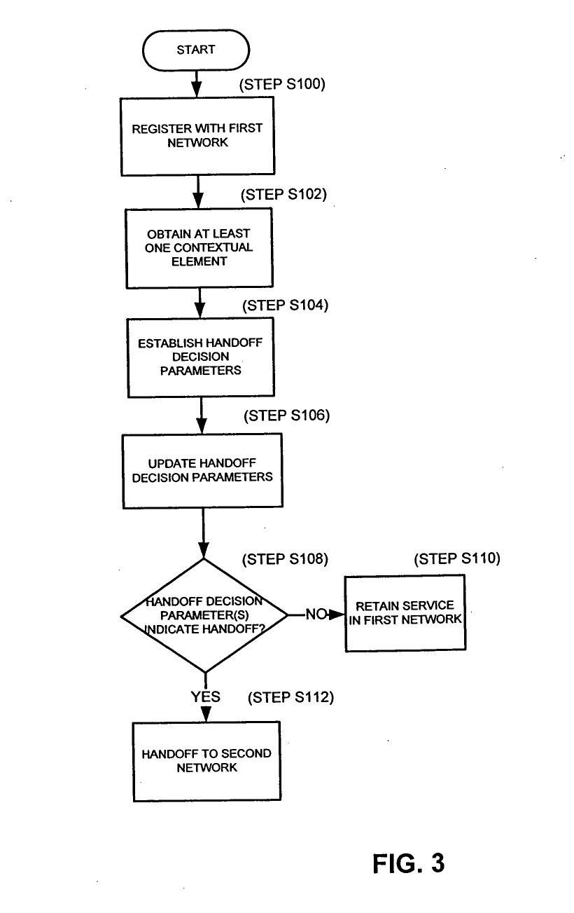

The operation of an embodiment of the handoff decision function 42 of network 100 is discussed with respect to the flowchart of FIG. 3. In step S100, a user device 30 registers with a first network, e.g., cellular domain. In step S102, at least one contextual element 50 is retrieved from the contextual information server 48. The one or more contextual elements 50 are provided to the HDF 32, which analyzes and uses the one or more contextual elements 50 to establish handoff decision parameters for the call session (step S104). If necessary or desired, at step S106, the handoff decision parameters may be updated, e.g., additional contextual elements 50 may be retrieved to establish additional handoff decision parameters for the call session. If, at step S108, the handoff decision parameters do not indicate a handoff to a second network, the service in the first network is retained (step S110). Otherwise, the system will notify the user device 30 to handoff the call session to the second network from the first network (step S112).

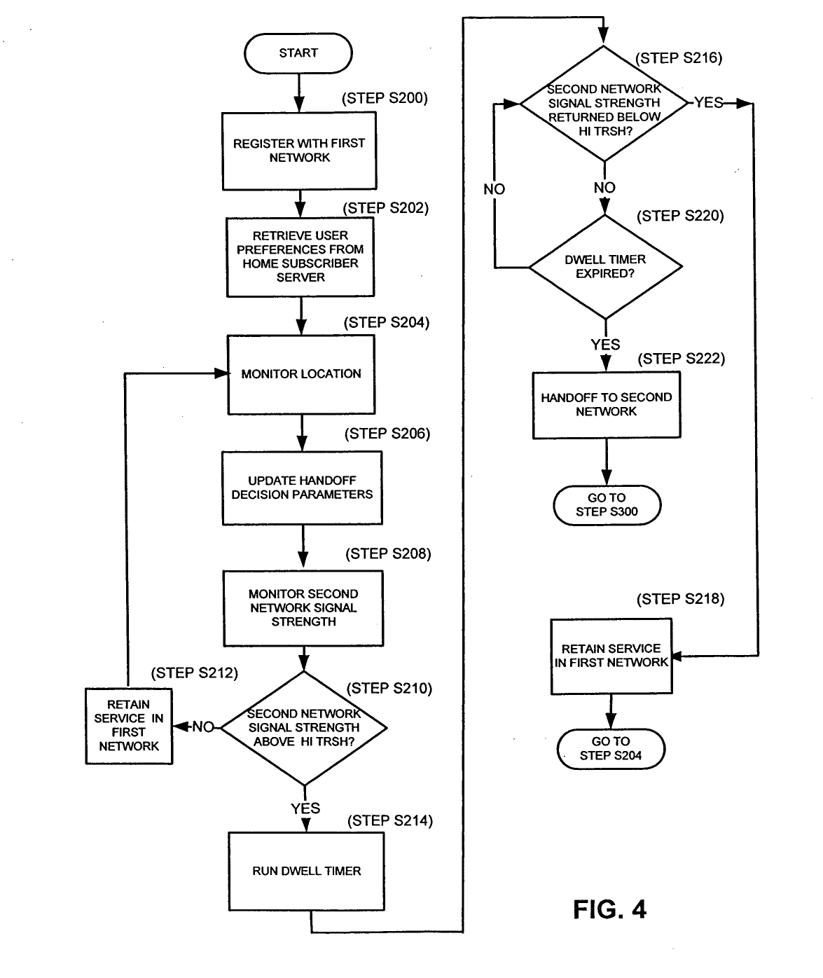

The operation of another embodiment of the handoff decision function 42 of the network 100 is discussed with respect to the flowchart of FIG. 4. In step S200, a user device 30 registers with a first network (e.g., cellular domain) and the user device's preferences are retrieved from the HSS server 52 (step S202). In step S204, the location of the user device 30 within the network 100 is monitored. If necessary or desired, at step S206, the HO decision parameters may be updated, e.g., select the proper parameter for that location or position in the network. At step S208, a second network, e.g., the Wi-Fi domain signal strength may be monitored. If, at step S210, the second network signal strength is not greater than a predetermined high threshold (“HI TRSH”), the service in the first network is retained and no handoff will occur (step S212). Otherwise, the system will run the dwell timer (step S214), and continue to monitor the second network signal strength to determine if the second network signal strength falls below the HI TRSH (step S216).

If the second network signal strength falls below the HI TRSH, the service in the first network is retained and no handoff will occur (step S218). Otherwise, determine if the dwell timer has expired (step S220) and if not, then the first network is retained and no handoff will occur and the second network signal strength is monitored to determine if it has fallen below the HI TRSH (step S216). If the dwell timer has expired, then the system will notify the user device 30 to handoff the call session to the second network from the first network (step S222).

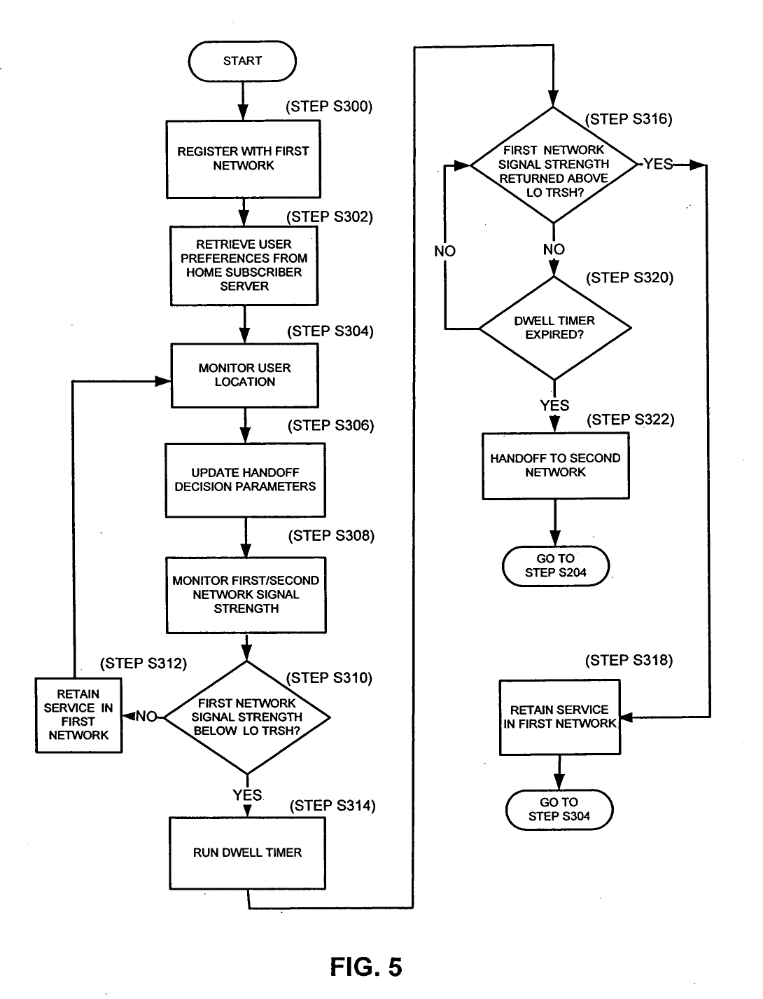

The operation of an embodiment of the handoff decision function 42 of the network 100 is discussed with respect to the flowchart of FIG. 5. In this example it is assumed that the user device 30 is currently in the first network, which is a Wi-Fi domain and a determination of whether a handoff to a cellular domain should take place. In step S300, a user device 30 registers with a first network, e.g., a Wi-Fi domain, and the user device's preferences are retrieved from the HSS server 52 (step S302). In step S304, the location of the user device 30 within the network 100 is monitored. If necessary or desired, at step S306, the HO decision parameters may be updated (e.g., select the proper parameter for that location or position in the network). At step S308, the first network (e.g., the Wi-Fi domain) signal strength and a second network (e.g., the cellular domain) signal strength may be monitored. If, at step S310, the first network signal strength is not below a predetermined lo threshold (“LO TRSH”), the service in the first network is retained and no handoff will occur (step S312). Otherwise, the system will run the dwell timer (step S314), and continue to monitor the first network signal strength to determine if the first network signal strength returns above the LO TRSH (step S316).

If the first network signal strength returns above the LO TRSH, the service in the first network is retained and no handoff will occur (step S318). Otherwise, determine if the dwell timer has expired (step S320) and if not, then the first network is retained and no handoff will occur and the first network signal strength is monitored to determine if it has returned above the LO TRSH (step S316). If the dwell timer has expired, then the system will notify the user device 30 to handoff the call session to the second network from the first network (step S322).

The present invention advantageously provides a method, system and apparatus for facilitating handoff of a mobile user device across inter-technology networks by employing a handoff decision function module that processes various contextual network wide status inputs and data, including user device network preferences. By employing this improved handoff scheme, the mobile end user will experience a seamless transition from one technology domain to another technology domain without interruption of a call session.

The present invention can be realized in hardware, software, or a combination of hardware and software. An implementation of the method and system of the present invention can be realized in a centralized fashion in one computing system or in a distributed fashion where different elements are spread across several interconnected computing systems. Any kind of computing system, or other apparatus adapted for carrying out the methods described herein, is suited to perform the functions described herein.

A typical combination of hardware and software could be a specialized or general-purpose computer system having one or more processing elements and a computer program stored on a storage medium that, when loaded and executed, controls the computer system such that it carries out the methods described herein. The present invention can also be embedded in a computer program product, which comprises all the features enabling the implementation of the methods described herein, and which, when loaded in a computing system is able to carry out these methods. Storage medium refers to any volatile or non-volatile storage device.

Computer program or application in the present context means any expression, in any language, code or notation, of a set of instructions intended to cause a system having an information processing capability to perform a particular function either directly or after either or both of the following a) conversion to another language, code or notation; b) reproduction in a different material form. In addition, unless mention was made above to the contrary, it should be noted that all of the accompanying drawings are not to scale. Significantly, this invention can be embodied in other specific forms without departing from the spirit or essential attributes thereof, and accordingly, reference should be had to the following claims, rather than to the foregoing specification, as indicating the scope of the invention.

It will be appreciated by persons skilled in the art that the present invention is not limited to what has been particularly shown and described herein above. A variety of modifications and variations are possible in light of the above teachings without departing from the spirit or essential attributes thereof, and accordingly, reference should be had to the following claims, rather than to the foregoing specification, as indicating the scope of the of the invention.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention, which is limited only by the following claims.

What is claimed is:

1. A system for facilitating handoffs between heterogeneous communication networks for a user device, the system comprising:
a first network having a first domain technology;
a second network having a second domain technology different from the first domain technology;
a contextual information server, the contextual information server storing contextual elements corresponding to a user device and the operating environment of the user device; and
a handoff decision function module, the handoff decision function module evaluating at least one of the contextual elements to determine whether to handoff user device communications from the first communication network to the second communication network.

2. The system of claim 1, wherein the handoff decision function module includes a statistical and self-learning module, the statistical and self-learning module applying measured handover rates to target handover rates to dynamically adjust handover decision parameters.

3. The system of claim 2, wherein the statistical and self-learning module records information regarding actual handoff rates among the heterogeneous communication networks.

4. The system of claim 1, further comprising a home subscriber server, the home subscriber server storing user call service network preferences of the user device.

5. The system of claim 1, further comprising a location module, the location module determining the location of the user device within the first communication network and the second communication network.

6. The system of claim 1, further comprising a received signal strength indication module, the received signal strength indication module determining the signal strength received by the user device within the first communication network and the second communication network.

7. A method for facilitating handoffs from a first communication network to a second communication network, the first communication network and second communication network being heterogeneous with respect to each other, the method comprising:
obtaining at least one contextual element corresponding to a user device and the operating environment of the user device;
evaluating the at least one contextual element with a handoff decision function module to establish a handoff decision;
establishing a handoff decision; and
notifying the user device of the handoff decision.

8. The method of claim 7, further comprising executing a handoff from the first communication network to the second communication network.

9. The method of claim 7, wherein obtaining at least one contextual element corresponding to a user device and the operating environment of the user device includes receiving a received signal strength indication.

10. The method of claim 7, wherein obtaining at least one contextual element corresponding to a user device and the operating environment of the user device includes receiving a link quality determination.

11. The method of claim 7, wherein obtaining at least one contextual element corresponding to a user device and the operating environment of the user device includes receiving a user device call service network preference.

12. The method of claim 7, wherein obtaining at least one contextual element corresponding to a user device and the operating environment of the user device includes receiving a characteristic of the user device.

13. The method of claim 7, wherein obtaining at least one contextual element corresponding to a user device and the operating environment of the user device includes determining a velocity of the user device.

14. The method of claim 7, wherein obtaining at least one contextual element corresponding to a user device and the operating environment of the user device includes determining a direction of the user device.

15. A method for facilitating handoffs from a first communication network to a second communication network, the first communication network and second communication network being heterogeneous with respect to each other, the method comprising:
obtaining at least one contextual element corresponding to a user device and the operating environment of the user device, the at least one contextual element establishing handoff parameters for evaluating a call session quality of service for a user device;
monitoring a signal strength received from the first network; and
evaluating the call session of the user device and applying the handoff parameters to the call session to determine whether to handoff user device communications from the first communication network to the second communication network.

16. The method of claim 15, wherein obtaining at least one contextual element corresponding to a user device and the operating environment of the user device includes monitoring a signal strength received from the second network.

17. The method of claim 16, wherein monitoring the signal strength received from the second network includes comparing the signal strength of the second network to a high threshold value, the high threshold value acting as a set point for call session handoff.

18. The method of claim 17, wherein monitoring the signal strength received from the second network includes determining if the signal strength of the second network has returned below the high threshold value.

19. The method of claim 15, wherein establishing handoff parameters for evaluating a call session quality of service for a user device includes determining the location of the user device within the first and second communication networks.

20. The method of claim 15, further comprising updating the handoff decision parameters based on the location of the user device in the network.
